(19) United States
(12) Patent Application Publication
(10) Pub. No.: US 2019/0325508 A1
(43) Pub. Date: Oct. 24, 2019

(54) QR Code Ordering Method and System for Restaurants

(71) Applicant: Michael Kaye, Holmfirth (GB)

(72) Inventor: Michael Kaye, Holmfirth (GB)

(21) Appl. No.: 15/955,692

(22) Filed: Apr. 18, 2018

(51) Int. Cl. G06Q 30/06; G06Q 50/12; G06K 7/14; G06Q 20/32

(52) U.S. Cl. CPC G06Q 30/0643; G06Q 20/3223; G06K 7/1417; G06Q 50/12

(57) ABSTRACT

A means of representing selections and favorites made on restaurant or coffee shop mobile or web based ordering Apps into graphical codes such as QR codes for single or repeated use when placing an order in person at the restaurant or electronically for delivery or collection. The system is a Graphical representation of selections using QR code and scanning technology to read graphical codes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### Field of the Invention

The present disclosure relates to methods and systems for ordering menu items through Cloud based server to host database. Comprising scanning technology to read graphical codes, such as QR codes, for use in such methods.

### Description of the Related Art

Placing a restaurant or coffee-shop order can be a slow and frustrating process especially when ordering for a group, memorizing and dictating detailed selections can lead to errors, omissions, compromises and disappointment. Mobile Apps are convenient for ordering food and beverages, storing favorites etc. However, communicating personal preferences to a friend or colleague who is compiling a group order remains a laborious, manual process, prone to errors, omissions, compromises and disappointment.

Mobile Apps (applications) currently exist for placing orders with takeaway restaurants for delivery or collection. These typically use the GPS (Global Positioning System) on the mobile device to identify the user's location and present a list of local takeaway restaurants. Orders are then sent electronically to the restaurant for collection or delivery. This solution is not suitable for an in-restaurant ordering system as GPS does not work indoors, and so an alternative approach is desirable for locating the customer.

These takeaway ordering systems also transmit the order to the restaurant in a standardized way and there is a problem of routing the order to the appropriate restaurant EPOS system using the required protocol and network.

However, to Applicant's knowledge, none of these prior art methods have been found to be completely suitable to meet these needs and are cumbersome. Thus, there is a need in the prior art to have graphical codes for placing orders. The present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

A means of representing selections and favorites made on restaurant or coffee shop mobile or web based ordering Apps into graphical codes such as QR codes for single or repeated use when placing an order in person at the restaurant or electronically for delivery or collection. Favorites/selections can be communicated to others electronically using any messaging platform or in printed form, displayed on cloud based platforms and shared via social media platforms. The user's profile can be shared with friends or publicly on cloud servers. Users can copy and synchronize favorite selections of celebrities they admire.

Embodiments of the invention relates to, a unique graphical code such as QR code which can be shared using any messaging platform or printed. The QR code is compatible with ‘Wallet’ type applications such as Apple Wallet, Google Wallet and similar. The code is presented on a mobile or wearable device or in printed form at the restaurant or coffee shop for scanning or communicated to the restaurant electronically and decoded into a food order for collection or delivery. Multiple codes can be combined into one or scanned individually at the counter or drive through order point.

Another embodiment of the invention is, an enhancement to be incorporated into established or new takeaway ordering Apps or as a standalone App receiving data from the restaurants' Apps.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 is a flow chart of a method in accordance with an embodiment of the present disclosure.

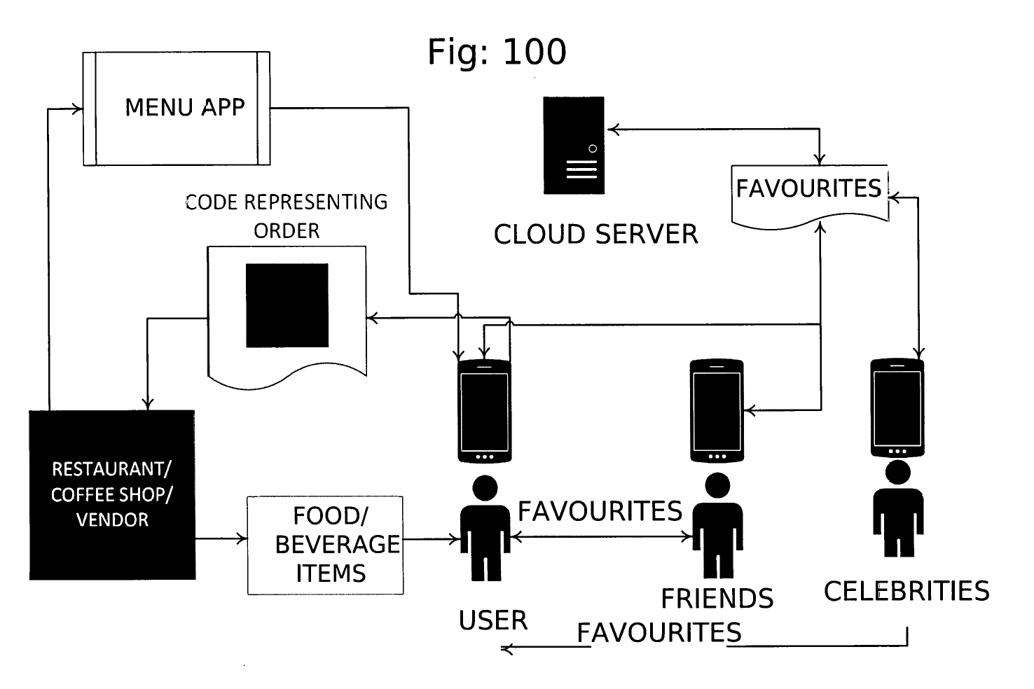

FIG. 200 shows a customized order generated with a code for a user.

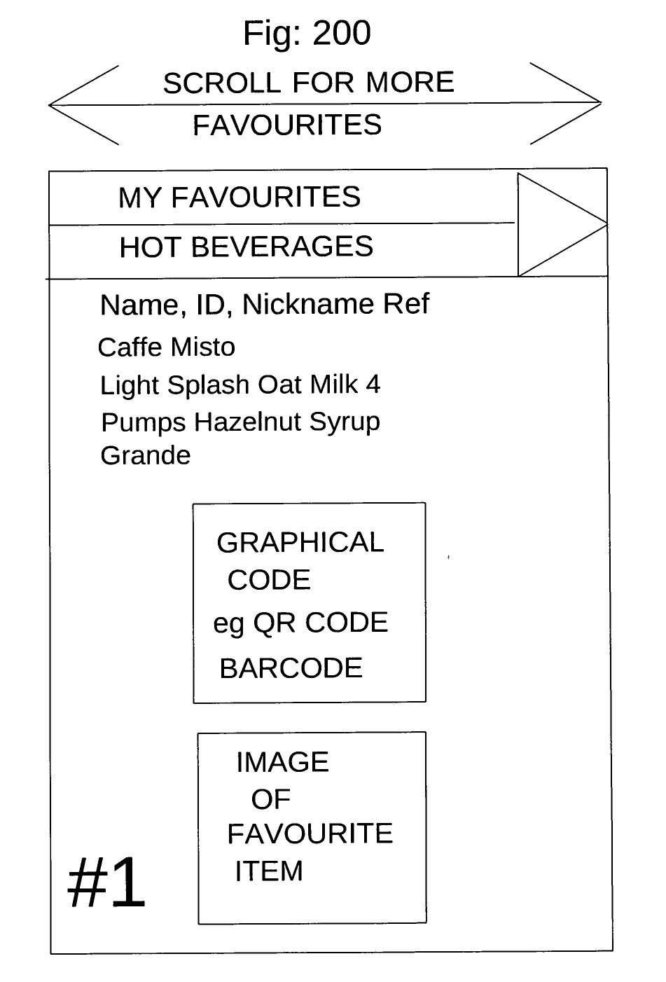

FIG. 300 shows multiple orders combined to make one order.

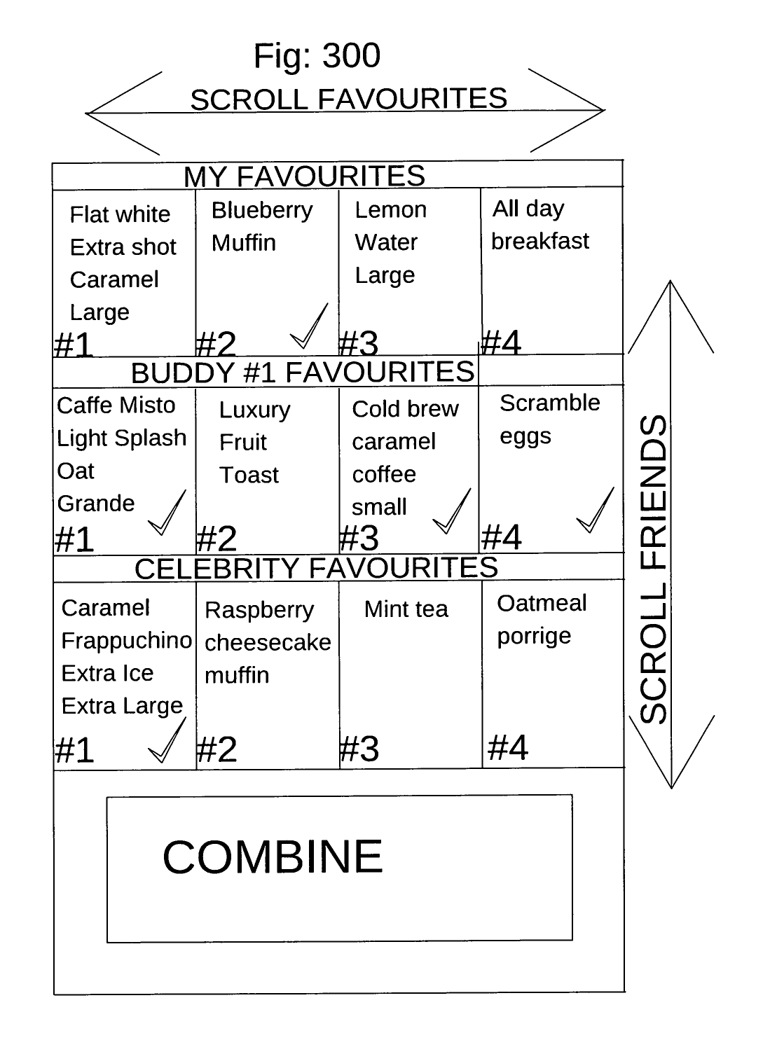

FIG. 400 shows order page with a billed amount for the user.

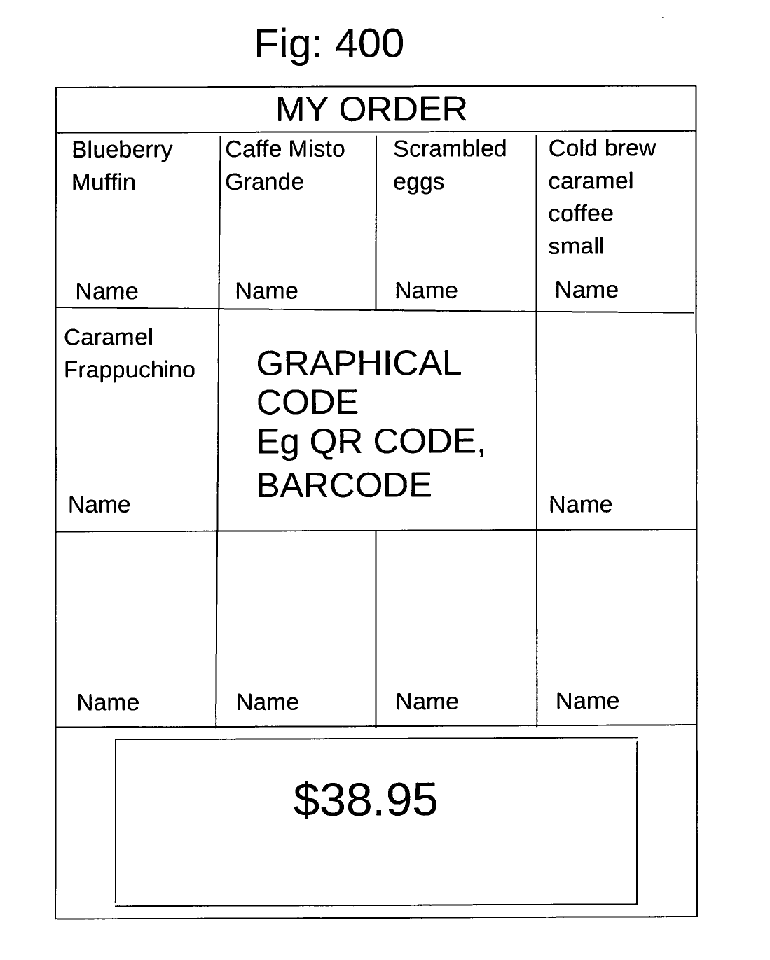

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before explaining the invention in detail, it is to be understood that the invention is not limited in its application to the detail of application illustrated in the drawings since the invention is capable of other embodiments and of being practiced or carried out in various ways. It is also to be understood that the phraseology or terminology employed is for the purpose of description only and not of limitation.

The present invention is a mean of representing selections and favorites made on restaurant or coffee shop mobile or web based ordering Apps into graphical codes such as QR codes for single or repeated use when placing an order in person at the restaurant or electronically for delivery or collection. Favorites/selections can be communicated to others electronically using any messaging platform or in printed form, displayed on cloud based platforms and shared via social media platforms. The user's profile can be shared with friends or publicly on cloud servers. Users can copy and synchronize favorite selections of celebrities they admire.

### Launch App

The App is launched to begin the process of enabling users to invite their friends to view each other's favorites. The invitation can be sent via all messaging platforms, the invitation includes a link to download the App for new users. Friends can share their personal favorites on the App to eliminate the need to memorize everyone's favorite foods and drinks. Friends can order for other members of the group confident that they will not disappoint. Groups or clubs can be formed where all members can share favorites with each other, an individual can be a member of an unlimited number of groups.

### Scan QR Code

The QR code order may be added to services such as Apple Wallet or Google Wallet, similar to a flight boarding pass. The QR code can be shared via electronic messaging services, for example—text, Whats-App, Twitter, Facebook, Instagram. Friends can quickly and accurately relay their order to the member of their party collecting the food. ‘Message me your order and I'll pick up’. The same QR code can be used repeatedly if the group or individual's order is unchanged. Orders for groups are ideal for this application, ‘After game team banquet’.

### Add Menu Items to Order

Favorites are hosted on a cloud server, users can choose whether or not to share their favorites publicly (via a link on their social media profile page), just with the Friends or remain private. Other users may choose to copy preferences of their friends or celebrities they follow. The user can select an avatar to represent their image or upload a selfie.

### Pay Order

The App does not require a link to an electronic payment system such as Apple pay or credit/debit cards, this feature will appeal to a younger audience who do not have such credit facilities and also older customers who are reluctant to divulge payment details due to security anxieties.

### Route Order

The restaurant may choose to have a fast-track line for QR orders. Selections communicated electronically rather than verbally will lead to reduced transaction times and eliminate order errors, with consequent operational efficiencies.

### Reviewing Orders and Multi Ordering

Users can browse menus at their leisure and take pleasure exploring the options in detail and optimizing their preferences. Ordering for a group will become a more relaxed, pleasurable and frequent experience.

The working of the app in Reality will be shown through following examples:

### EXAMPLE 1

### Simplest Application of the Model

1. The user browses the menu on the restaurant App and makes his selections, for himself alone or his party.

2. At the checkout touching the ‘Add to Wallet’ button adds the QR code to Apple/Google Wallet in a similar manner to a boarding pass.

3. The user can complete payment and then touch the ‘Add to Wallet’ button. This code is for single use and expires once used.

4. When the user is at the restaurant he presents the QR code for scanning and his order is accepted and processed.

5. If payment was not incorporated in the code, the user makes payment by his preferred method.

6. If payment was included the payment expires once used, but remains in the wallet unless deleted.

7. The App is available in multiple languages to enable easy ordering when visiting foreign speaking countries. The QR codes are universal, independent of language.

### EXAMPLE 2

### Ordering for a Group of Friends or Colleagues

1. Users can invite friends to share each other's favorites.

2. From the favorites page of the App the user who will be placing the order can see his and his friends' favorites.

3. Scrolling up reveals more friends, scrolling left revels more favorites.

4. The user taps each favorite to add to his order; multiple choices can be made for each friend.

5. Once all selections have been made the user taps the ‘Compile my order’ button which translates the selections into a single QR code which can be presented for scanning.

6. Payment may or may not be incorporated into the QR code.

### EXAMPLE 3

### As a Gift or Favor Request

1. Users can share prepaid codes with others, ‘I'll send you a ticket’. The code can be shared via messaging platforms, to gift a meal/drink to a family member/friend/colleague or request they bring you said meal/drink as a favor.

2. The recipient does not have to be a user of the App to redeem the gift.

### EXAMPLE 4

### Promoting New Additions to the Vendors' Menu

1. Media advertising promoting a particular beverage, dish or meal can be accompanied by a scan-able code which the user can scan and subsequently present at the appropriate vendor to be recognized as a request for the advertised beverage, dish or meal.

2. Payment may or may not be incorporated into the QR code according to the advertiser's preference. If the promotion incorporates prepayment, the restaurant may choose to limited orders by total quantity (Free cappuccinos to first 500 customers) or expiry date/time.

### EXAMPLE 5

### Sharing Favorite Online, Copying Celebrity Favorites

1. Friends can share their favorites with each other via a cloud server, refinements, additions and deletions are shared instantly as tastes and preferences change.

2. Users can add new and delete old selections as they please, their favorites are synchronized through the cloud server. The user can customize notifications, ‘Polly has added a new favorite’.

3. Favorites can be copied and shared via all social platforms, printed and added to the user's favorites via the QR reader on the mobile device.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I claim:

1) (canceled)

2) (canceled)

3) (canceled)

4) (canceled)

5) (canceled)

6) (canceled)

7) (canceled)

8) (canceled)

9) (canceled)

10) App or website which converts menu selection into a unique graphical code such as QR code for single or repeated use while ordering at a restaurant which can be shared using any electronically messaging platform or through printed medium.

11) Multiple codes that can be combined into one or scanned individually at the counter or drive through order point which can be can be edited, shared or permanently deleted, users can also copy and synchronize favorite codes of celebrities they admire.

12) Scanners may be incorporated into restaurant dining tables to read the QR code. A notification is sent to the App when the order is ready for collection.
